(19) United States
(12) Patent Application Publication
(10) Pub. No.: US 2009/0104815 A1
(43) Pub. Date: Apr. 23, 2009

(54) Cable arrangement with shielded cables

(76) Inventor: Stefan Reker, Bielefeld (DE)

Correspondence Address: LAUBSCHER & LAUBSCHER, P.C., 1160 SPA ROAD, SUITE 2B, ANNAPOLIS, MD, 21403, US

(21) Appl. No.: 12/287,552

(22) Filed: Oct. 10, 2008

(30) Foreign Application Priority Data
Oct. 15, 2007 (DE) 20 2007 014 490.3

(51) Int. Cl. H01R 9/03

(52) U.S. Cl. 439/607.41

(57) ABSTRACT

Connector apparatus electrically connects together a plurality of shielded cables, including a housing containing a chamber including a first opening for receiving one end of a first shielded cable, and at least two second openings receiving the one ends of at least two second shielded cables, respectively. A conductive shield associated with the housing connects together the shielding layers of all of the cables, and a printed circuit board arranged in the housing connects at least one conductor of at least two of the second cables with a corresponding conductor of the first cable.

### BACKGROUND OF THE INVENTION

1. Field of the Invention

Connector apparatus electrically connects together a plurality of shielded cables, including a housing containing a chamber including a first opening for receiving one end of a first shielded cable, and at least two second openings receiving the one ends of at least two second shielded cables, respectively. A conductive shield associated with the housing connects together the shielding layers of all of the cables, and a printed circuit board arranged in the housing connects at least one conductor of at least two of the second cables with a corresponding conductor of the first cable.

2. Description of Related Art

In the field of automation techniques, one repeatedly encounters the problem with cables having patch connectors using the so-called M-standard (i.e., M8 or M12 standard), of making suitable twin or T-shaped connections. Currently, the solutions to these problems include: (a) the use of commonly manufactures patch connectors with a cable screw connection having two inputs, (b) a T-piece connection without cable and having three plugs, and (c) one line where two cables come out of one plug. These solutions work well for unshielded electrical cables, but they are not suitable for shielded cables because the cable shields cannot readily be placed twice on a single plug.

The present invention was developed to provide an improved T-type connection for shielded cables.

### SUMMARY OF THE INVENTION

Accordingly, a primary object of the present invention is to provide a connector housing including shield means for connecting together all of the shielding layers of a plurality of shielded conductors, and connecting means for connecting together certain conductors of a plurality of second cables with a corresponding conductor of a first cable. Preferably, the conductor connecting means includes a printed circuit board having T-shaped strip conductors.

According to a first embodiment of the invention, the connector housing is formed from an electrically insulting synthetic plastic material, and the shield means comprises either a layer of conductive shielding metallic material lining the interior wall of the housing, or a layer of sheet metal shielding material enclosing the connecting means. According to a second embodiment, the connector housing is formed of conductive metal and serves itself as the shield means for the connecting means.

According to another feature of the invention, prefabricated plug or socket connectors are connected with the other ends of the shielded cables.

### BRIEF DESCRIPTION OF THE DRAWINGS

Other objects and advantages of the invention will become apparent from a study of the following specification, when viewed in the light of the accompanying drawing, in which:

FIG. 1 is a diagrammatic illustration of the connector arrangement of the present invention for connecting together a plurality of shielded conductors; and

FIG. 2 is a perspective view of a plurality of shielded cables connected together by the connector means of the present invention.

### DETAILED DESCRIPTION OF THE INVENTION

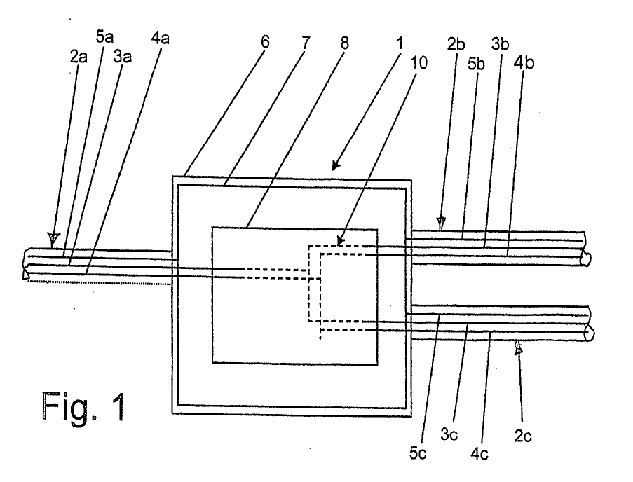

Referring first more particular to the diagrammatic representation of FIG. 1, the connector apparatus 1 of the present invention includes a housing 6 containing a chamber and having a first opening for receiving one end of a first shielded cable 2a, and a pair of second openings for receiving the one ends of a pair of second shielded cables 2b and 2c. said cables containing a plurality of conductors 3a,4a; 3b,4b; and 3c,4c, respectively, and a conductive cable shield means 5a, 5b, and 5c, respectively. The housing 6 contains housing shield means 7 to which are electrically connected (for example, by soldering) each of the cable shield means 5a-5c. The housing chamber also contains a printed circuit board 8 having T shaped printed conductor strips thereon which electrically connect certain conductors of the second cables with a corresponding conductor of the first cable (i.e., conductors 3b and 3c are connected with conductor 3a, and conductors 4b and 4c are connected with conductor 4a).

Preferably the housing 6 is formed from an electrically insulating synthetic plastic material, and the shield means 7 comprises a layer of conductive metallic material lining the inner wall surface of the chamber. Alternatively, the shield means could be formed from conductive metal sheet material. In a second embodiment, the housing 6 is formed from a conductive metallic material, whereby the housing serves as the shield means.

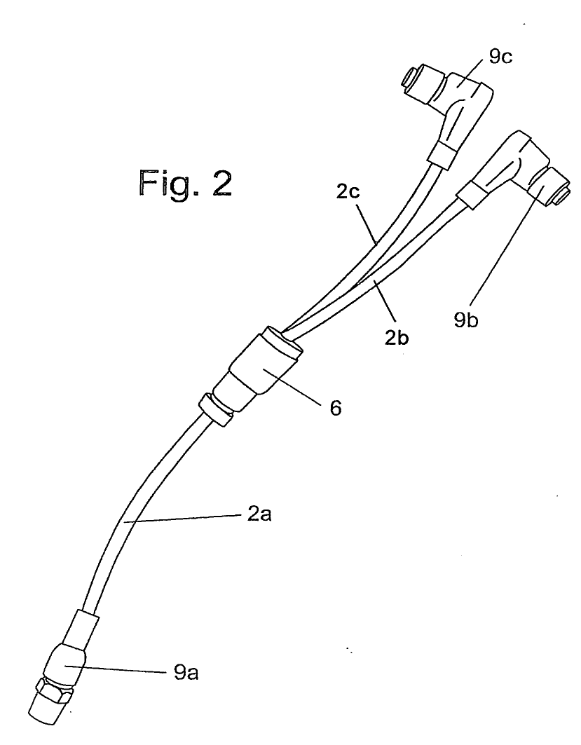

As shown in FIG. 2, plug or socket M-type connectors 9a, 9b and 9c (such as M8 or M12 connectors) are provided, preferably in a pre-assembled manner, at the second ends of the cables 2a, 2b and 2c, respectively.

Housing 6 can have any desired shape. Particularly suitable would be a sleeve design provided at its ends with one or two passages for the cables, which sleeve design is closed and metal coated, or a flat housing coated on its interior with a metal layer, which connector after assembly is cast with sealant to achieve a high degree of impermeability. Also, it is conceivable to use a solid metal housing so that the housing serves as the metal shield.

The cable device, thus prefabricated, can easily be connected with additional patch plug parts in order to make a shielded T-piece connection with shielded cables.

While in accordance with the provisions of the Patent Statutes the preferred forms and embodiments of the invention have been illustrated and described, it will be apparent to those skilled in the art that changes may be made without deviating from the invention described above.

What is claimed is:

1. Connector apparatus for electrically connecting together a plurality of electrical shielded cables each having a plurality of conductors, and a conductive shielding layer electrically shielding said conductors, comprising:
(a) a connector housing (6) containing a chamber, said housing including a first opening for receiving one end of a first cable (2a), and at least two second openings receiving the one ends of at least two second cables (2b, 2c), respectively;
(b) shield means (7) associated with said housing for connecting together the shielding layers of all of the cables; and
(c) connecting means (8) arranged in said housing for connecting at least one conductor (3b, 4b; 3c, 4c) of at least two of the second cables with a corresponding one conductor (3a, 4a) of the first cable.

2. Connector apparatus as defined in claim 1, wherein said housing is formed from an electrical insulating synthetic plastic material.

3. Connector apparatus as defined in claim 2, wherein said shield means comprises a metal coating lining said housing chamber.

4. Connector apparatus as defined in claim 2, wherein said shield means comprises a layer of conductive metal sheet material arranged in said chamber.

5. Connector apparatus as defined in claim 1, wherein said connecting means includes a printed circuit board (8) having conductive strips arranged in said chamber for electrically connecting together associated ones of said cable conductors.

6. Connector apparatus as defined in claim 1, and further including electrical connector means (9a, 9b, 9c) connected with the other ends of said cables, respectively

7. Connector apparatus as defined in claim 1, wherein said housing is made of a conductive metallic material, whereby said housing comprises said shield means.
